(19) United States
(12) Patent Application Publication
(10) Pub. No.: US 2011/0278967 A1
(43) Pub. Date: Nov. 17, 2011

(54) ROTOR FOR ELECTRIC ROTATING MACHINE

(75) Inventor: Ryosuke UTAKA, Takahama-shi (JP)

(73) Assignee: DENSO CORPORATION, Kariya-city (JP)

(21) Appl. No.: 13/106,151

(22) Filed: May 12, 2011

(30) Foreign Application Priority Data
May 12, 2010 (JP) 2010-110292
Apr. 22, 2011 (JP) 2011-096441

(51) Int. Cl. H02K 9/22

(52) U.S. Cl. 310/52

(57) ABSTRACT

A rotor for an electric rotating machine includes a hollow cylindrical rotor core, a plurality of permanent magnets, at least one annular plate and a plurality of heat conductors. The rotor core has a pair of axial end faces that are opposite to each other in the axial direction of the rotor core. The permanent magnets are embedded in the rotor core so as to be spaced from one another in the circumferential direction of the rotor core. The at least one annular plate is disposed in abutment with a corresponding one of the axial end faces of the rotor core. The heat conductors are embedded in the rotor core. Each of the heat conductors extends so as to have an end thereof abutting the at least one annular plate.

### CROSS-REFERENCE TO RELATED APPLICATIONS

This application is based on and claims priority from Japanese Patent Applications No. 2010-110292 filed on May 12, 2010 and No. 2011-96441 filed on Apr. 22, 2011, the contents of which are hereby incorporated by reference in their entireties into this application.

### BACKGROUND

1. Technical Field

The present invention relates generally to rotors for electric rotating machines that are used in, for example, motor vehicles as electric motors and electric generators. More particularly, the invention relates to a rotor for an electric rotating machine which has an improved structure for effectively cooling permanent magnets embedded in a rotor core of the rotor.

2. Description of Related Art

A conventional rotor for an electric rotating machine, such as the one disclosed in Japanese Patent Application Publication No. 2006-353041, includes a rotor core, a plurality of permanent magnets, and a pair of annular end plates. The rotor core is formed by laminating, for example, a plurality of annular steel sheets in the axial direction of the rotor core. The permanent magnets are embedded in the rotor core so as to be spaced in the circumferential direction of the rotor core at predetermined intervals. The end plates are respectively fixed on a pair of axial end faces of the rotor core.

FIG. 8 is an axial end view of part of the conventional rotor 1, omitting the end plate fixed on the axial end face of the rotor core. In operation, with rotation of the rotor 1, eddy current will be induced, by the change in magnetomotive force of a stator (not shown) which is disposed radially outside the rotor 1, in the rotor 1 to flow through the permanent magnets 2, thereby causing the permanent magnets 2 to generate heat. The generated heat then will be transferred, as indicated with arrowed lines Y1 in FIG. 8, from the permanent magnets 2 to a rotating shaft (not shown) via the rotor core. Thereafter, the heat will be removed from the rotating shaft by lubricating oil that flows along the rotating shaft. As a result, the permanent magnets 2 can be cooled.

Japanese Patent Application Publication No. 2008-219960 discloses another type of rotor which has a coolant passage formed therein. More specifically, the coolant passage is formed in the rotor core so as to axially extend on the radially inner side of the permanent magnets. Consequently, during rotation of the rotor, the heat generated by the permanent magnets can be removed by coolant flowing through the coolant passage.

However, with either of the above cooling mechanisms disclosed in the prior art, it is difficult to cool radially-outer parts of the permanent magnets as effectively as cooling radially-inner parts of the same. Moreover, the change in magnetomotive force of the stator will induce larger eddy current to flow through the radially-outer parts of the permanent magnets and thus cause the radially-outer parts to generate more heat in comparison with the radially-inner parts. Consequently, the temperature of the permanent magnets will increase at the radially-outer parts, resulting in a local drop in the coercivity of the permanent magnets.

### SUMMARY

According to the present invention, there is provided a rotor for an electric rotating machine which includes a hollow cylindrical rotor core, a plurality of permanent magnets, at least one annular plate and a plurality of heat conductors. The rotor core has a pair of axial end faces that are opposite to each other in the axial direction of the rotor core. The permanent magnets are embedded in the rotor core so as to be spaced from one another in the circumferential direction of the rotor core. The at least one annular plate is disposed in abutment with a corresponding one of the axial end faces of the rotor core. The heat conductors are embedded in the rotor core. Each of the heat conductors extends so as to have an end thereof abutting the at least one annular plate.

With the above structure of the rotor, in operation of the electric rotating machine, eddy current will be induced, by the change in magnetomotive force of a stator of the electric rotating machine, in the rotor to flow through the permanent magnets, thereby causing the permanent magnets to generate heat. The generated heat then will be transferred from the permanent magnets to the heat conductors via the rotor core, and further transferred from the heat conductors to the at least one end plate. Thereafter, part of the heat will be directly dissipated from the at least one end plate to the atmosphere; the remaining part will be transferred from the at least one end plate to, for example, a rotating shaft of the electric rotating machine and then removed from the rotating shaft by means of lubricating oil that flows along the rotating shaft. Consequently, it is possible to effectively cool the permanent magnets, thereby reliably suppressing the increase in temperature of the permanent magnets due to the heat generated thereby. As a result, it is possible to prevent the coercivity of the permanent magnets from being lowered, thereby ensuring high reliability of the rotor.

It is preferable that the heat conductors are positioned in the rotor core so as to be closer to the stator of the electric rotating machine than the permanent magnets are.

The number of the heat conductors may be equal to the number of the permanent magnets. In this case, it is preferable that each of the heat conductors is embedded in the rotor core in the vicinity of a corresponding one of the permanent magnets.

Otherwise, the number of the heat conductors may be equal to half the number of the permanent magnets. In this case, it is preferable that each of the heat conductors is embedded in the rotor core in the vicinity of a corresponding circumferentially-adjacent pair of the permanent magnets so as to be equidistant from the corresponding pair of the permanent magnets.

Each of the heat conductors may be partially embedded in the rotor core to have one surface thereof exposed from the rotor core.

The rotor core is comprised of a plurality of steel sheets that are laminated in the axial direction of the rotor core with a plurality of insulating layers interposed therebetween. In this case, it is preferable that the heat conductors have a higher heat conductivity than the insulating layers. It is also preferable that the at least one annular plate has a higher heat conductivity than the insulating layers.

The at least one annular plate may include a pair of annular plates that are disposed to respectively abut the axial end faces of the rotor core. In this case, it is preferable that each of the heat conductors extends so as to have a pair of axial ends thereof respectively abutting the pair of the annular plates.

Otherwise, the at least one annular plate may include only a single annular plate.

It is preferable that the heat conductors have a lower electrical conductivity than the steel sheets forming the rotor core.

It is also preferable that the heat conductors have a lower magnetic permeability than the steel sheets.

Each of the heat conductors may be formed in one piece and arranged to extend in the axial direction of the rotor core.

Otherwise, each of the heat conductors may be comprised of a plurality of heat conductor segments that are arranged in the axial direction of the rotor core so as to partially abut one another and are offset from one another in the circumferential direction of the rotor core.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is a schematic, partially cross-sectional view of an electric rotating machine which includes a rotor according to an embodiment of the invention;

FIG. 2 is an axial end view of part of the rotor;

FIG. 3 is a schematic, partially cross-sectional view of part of the rotor illustrating heat conduction paths formed in a rotor core of the rotor for conducting heat generated by permanent magnets embedded in the rotor core;

FIG. 4 is a schematic, partially cross-sectional view of part of the rotor illustrating the flow of heat generated by the permanent magnets in the rotor;

FIG. 5 is an axial end view of part of a rotor according to the first modification to the embodiment;

FIG. 6 is an axial end view of part of a rotor according to the second modification to the embodiment;

FIG. 7A is an axial end view of part of a rotor according to the third modification to the embodiment;

FIG. 7B is a cross-sectional view of the rotor according to the third modification taken along the line A-A in FIG. 7A; and

FIG. 8 is an axial end view of part of a conventional rotor.

### DESCRIPTION OF PREFERRED EMBODIMENT

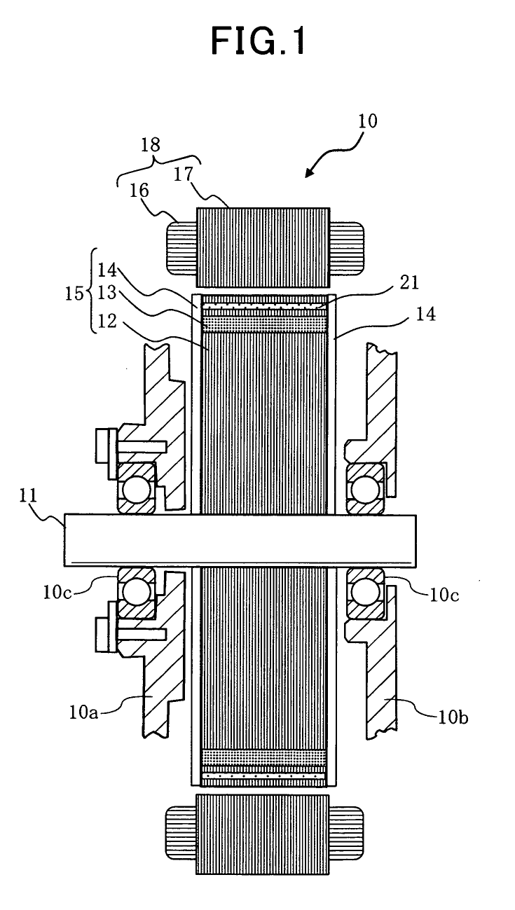

FIG. 1 shows the overall configuration of an electric rotating machine 10 which includes a rotor 15 according to an embodiment of the invention. The electric rotating machine 10 is configured to function, for example, as an electric motor in a hybrid or electric vehicle.

As shown in FIG. 1, the electric rotating machine 10 includes: a pair of front and rear housings 10a and 10b (only partially shown) that are fixed together by means of a plurality of bolts (not shown) and have a pair of bearings 10c respectively arranged therein; a rotating shaft 11 that is rotatably supported by the front and rear housings 10a and 10b via the bearings 10c; the rotor 15 that is fixed on the rotating shaft 11 and received in the front and rear housings 10a and 10b; and a stator 18 that is held between the front and rear housings 10a and 10b and disposed radially outside and coaxially with the rotor 15. In addition, in the present embodiment, the stator 18 functions as an armature while the rotor 15 functions as a field of the electric rotating machine 10.

Specifically, the stator 18 includes a hollow cylindrical stator core 17 and a three-phase stator coil 16.

The stator core 17 has a plurality of slots (not shown) that are formed in the radially inner surface of the stator core 17 and spaced in the circumferential direction of the stator core 17. The stator core 17 is formed by laminating a plurality of annular steel sheets in the axial direction of the stator core 17.

The stator coil 16 is mounted on the stator core 17 so as to be partially received in the slots of the stator core 17. The stator coil 16 is electrically connected to a three-phase inverter (not shown).

The rotor 15 includes a hollow cylindrical rotor core 12, a plurality of permanent magnets 13 and a pair of annular end plates 14.

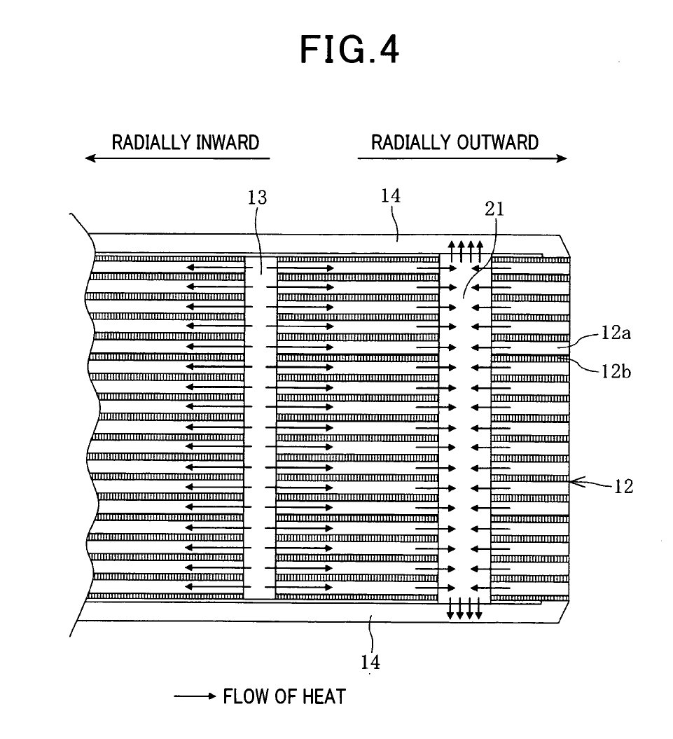

The rotor core 12 is coaxially fixed on the rotating shaft 11 so that the radially outer periphery of the rotor core 12 faces the radially inner periphery of the stator core 17 with a predetermined annular gap formed therebetween. Referring to FIG. 4, in the present embodiment, the rotor core 12 is formed by laminating a plurality of annular steel sheets 12a in the axial direction of the rotor core 12. Moreover, between each axially-adjacent pair of the steel sheets 12a, there is provided an insulating layer 12b that is made of, for example, epoxy or acrylic resin.

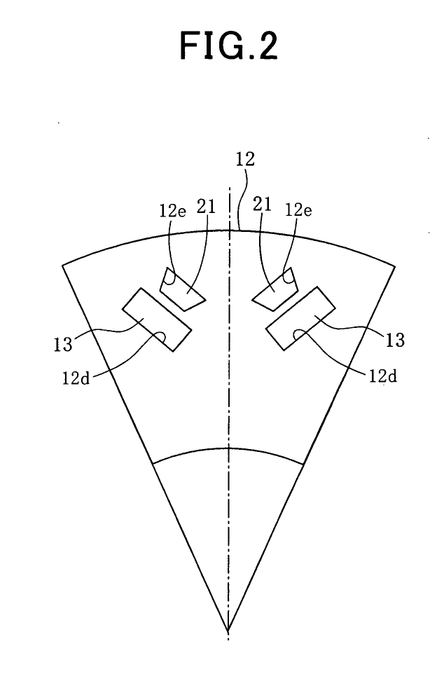

The permanent magnets 13 are embedded in the rotor core 12, as shown in FIG. 2, so as to form a plurality of magnetic poles on the radially outer periphery of the rotor core 12. The magnetic poles are arranged in the circumferential direction of the rotor core 12 at predetermined intervals so that the polarities of the magnetic poles alternate between north and, south in the circumferential direction. In addition, the number of the magnetic poles is set to be equal to, for example, eight (i.e., four north poles and four south poles) in the present embodiment.

More specifically, referring to FIG. 2, in the present embodiment, the rotor core 12 has eight pairs of through-holes 12d formed in the vicinity of the radially outer periphery of the rotor core 12. Each of the through-holes 12d extends in the axial direction of the rotor core 12 to penetrate the rotor core 12. The eight pairs of the through-holes 12d are spaced in the circumferential direction of the rotor core 12 at predetermined intervals. Moreover, each pair of the through-holes 12d is arranged to form a substantially truncated V-shape opening toward the radially outer periphery of the rotor core 12.

Each of the permanent magnets 13 is held in a corresponding one of the through-holes 12d of the rotor core 12 so as to extend in the axial direction of the rotor core 12. Moreover, for each pair of the through-holes 12d of the rotor core 12, the two permanent magnets 13 which are respectively held in the pair of the through-holes 12d are arranged so that the polarities (north or south) of the two permanent magnets 13 are the same on the radially outer side. Consequently, the two permanent magnets 13 together form one of the magnetic poles on the radially outer periphery of the rotor core 12.

The annular end plates 14 are both fitted on the rotating shaft 11 and respectively fixed to a pair of axial end faces of the rotor core 12. The annular end plates 14 are made of a non-magnetic material, for example aluminum or stainless steel.

Furthermore, in the present embodiment, the rotor core 12 also has eight pairs of through-holes 12e. Each of the through-holes 12e is formed radially outside and in close vicinity to a corresponding one of the through-holes 12d. Each of the through-holes 12e extends in the axial direction of the rotor core 12 to penetrate the rotor core 12. Moreover, similar to the pairs of the through-holes 12d, each pair of the through-holes 12e is also arranged to form a substantially truncated V-shape opening toward the radially outer periphery of the rotor core 12.

In each of the through-holes 12e of the rotor core 12, there is embedded one heat conductor 21. Accordingly, the rotor core 12 has a total of sixteen heat conductors 21 embedded therein. Each of the heat conductors 21 extends in the axial direction of the rotor core 12 and has a pair of axial ends respectively abutting the annular end plates 14 that are respectively fixed to the axial end faces of the rotor core 12.

In the present embodiment, the heat conductors 21 are made of a material that has a higher heat conductivity than the insulating layers 12b of the rotor core 12 and a lower electrical conductivity (or a higher resistivity) and a lower magnetic permeability than the steel sheets 12a of the rotor core 12. It should be noted that the heat conductors 21 may also be made of a material that has a higher heat conductivity than the insulating layers 12b and has either a lower electrical conductivity or a lower magnetic permeability than the steel sheets 12a.

In operation of the electric rotating machine 1, with rotation of the rotor 15, eddy current will be induced, by the change in magnetomotive force of the stator 18, in the rotor 15 to flow through the permanent magnets 13, thereby causing the permanent magnets 13 to generate heat. In particular, compared to radially-inner parts of the permanent magnets 13, radially-outer parts of the permanent magnets 13 are positioned closer to the stator 18; therefore, the change in magnetomotive force of the stator 18 will induce larger eddy current to flow through the radially-outer parts and thus cause the radially-outer parts to generate more heat.

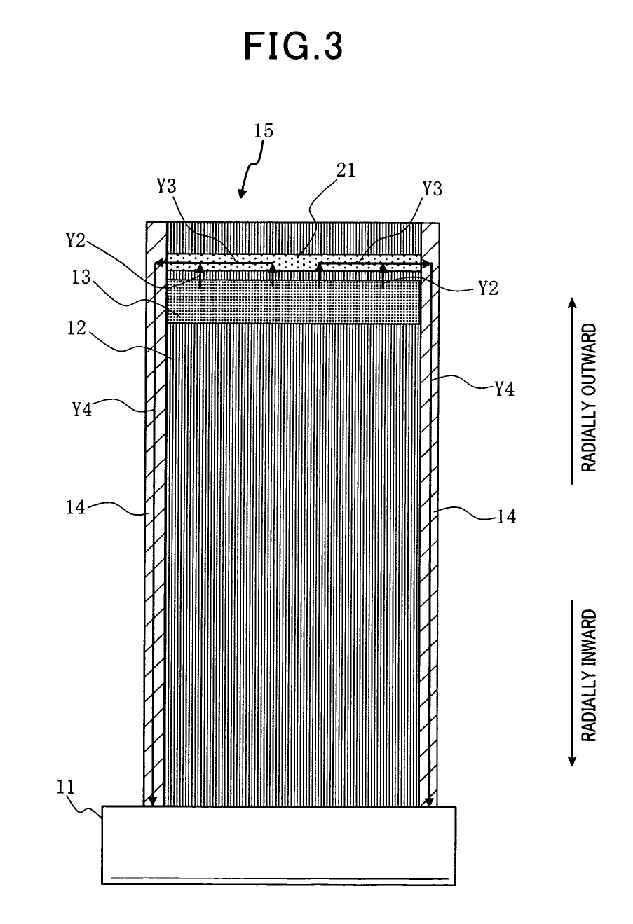

The heat generated by the radially-outer parts of the permanent magnets 13 then will be transferred to the heat conductors 21 via the steel sheets 12a of the rotor core 12 as indicated with the arrowed lines Y2 in FIG. 3, and further transferred from the heat conductors 21 to the end plates 14 as indicated with the arrowed lines Y3 in FIG. 3. Thereafter, part of the heat will be dissipated from the end plates 14 directly to the atmosphere; the remaining part will be transferred from the end plates 14 to the rotating shaft 11 as indicated with the arrowed lines Y4 in FIG. 3, and finally removed from the rotating shaft 11 by means of lubricating oil that flows along the rotating shaft 11.

On the other hand, as shown in FIG. 4, the heat generated by the radially-inner parts of the permanent magnets 14 will be transferred radially inward to the rotating shaft 11 and then removed from the rotating shaft 11 by means of the lubricating oil.

Consequently, with the above heat conduction paths formed in the rotor 15, it is possible to effectively cool all parts of the permanent magnets 13, thereby reliably suppressing the increase in temperature of the permanent magnets 13 due to the heat generated thereby.

After having described the overall configuration of the rotor 15 according to the present embodiment, advantages thereof will be described hereinafter.

In the present embodiment, the rotor 15 includes the hollow cylindrical rotor core 12, the permanent magnets 13 that are embedded in the rotor core 12 so as to be spaced from one another in the circumferential of the rotor core 12, the annular plates 14 that are disposed to respectively abut the axial end faces of the rotor core 12, and the heat conductors 21 embedded in the rotor core 12. Each of the heat conductors 21 extends in the axial direction of the rotor core 12 to have the axial ends thereof respectively abutting the annular plates 14.

With the above structure of the rotor 15, in operation of the electric rotating machine 10, eddy current will be induced, by the change in magnetomotive force of the stator 18, in the rotor 15 to flow through the permanent magnets 13, thereby causing the permanent magnets 13 to generate heat. The generated heat then will be transferred from the permanent magnets 13 to the heat conductors 21 via the rotor core 12, and further transferred from the heat conductors 21 to the end plates 14. Thereafter, part of the heat will be dissipated from the end plates 14 directly to the atmosphere; the remaining part will be transferred from the end plates 14 to the rotating shaft 11 and finally removed from the rotating shaft 11 by means of lubricating oil that flows along the rotating shaft 11. Consequently, it is possible to effectively cool the permanent magnets 13, thereby reliably suppressing the increase in temperature of the permanent magnets 13 due to the heat generated thereby. As a result, it is possible to prevent the coercivity of the permanent magnets 13 from being lowered, thereby ensuring high reliability of the rotor 15.

Further, in the present embodiment, the rotor core 12 is disposed radially inside the stator 18 so as to face the stator 18 in the radial direction of the rotor core 12. The heat conductors 21 are positioned in the rotor core 12 closer to the stator 18 than the permanent magnets 13 are.

With the above relative position between the rotor 15 and the stator 18, the change in magnetomotive force of the stator 18 will induce larger eddy current to flow through the radially-outer parts of the permanent magnets 13 and thus cause the radially-outer parts to generate more heat in comparison with the radially-inner parts of the permanent magnets 13. However, with the above positioning of the heat conductors 21, it is still possible to effectively cool all parts of the permanent magnets 13, thereby reliably preventing a local drop in the coercivity of the permanent magnets 13.

In the present embodiment, the number of the heat conductors 21 is equal to the number of the permanent magnets 13. Each of the heat conductors 21 is embedded in the rotor core 12 in the vicinity of a corresponding one of the permanent magnets 13.

With the above arrangement, it is possible to effectively cool each of the permanent magnets 13 by means of the corresponding heat conductor 21.

In the present embodiment, the rotor core 12 is comprised of the steel sheets 12a that are laminated in the axial direction of the rotor core 12 with the insulating layers 12b interposed therebetween. The heat conductors 21 have a higher heat conductivity than the insulating layers 12b.

Consequently, it is possible for the heat conductors 21 to is effectively conduct the heat generated by the permanent magnets 13 to the end plates 14.

Further, in the present embodiment, the end plates 14 also have a higher heat conductivity than the insulating layers 12b.

Consequently, it is possible for the end plates 14 to effectively conduct the heat generated by the permanent magnets 13 to the rotating shaft 11.

In the present embodiment, the rotor 15 includes the pair of the end plates 14 that are disposed to respectively abut the axial end faces of the rotor core 12. In other words, for each of the axial end faces of the rotor core 12, there is provided one end plate 14.

Consequently, with the two end plates 14, it is possible to effectively dissipate the heat generated by the permanent magnets 13 to the atmosphere.

In the present embodiment, the heat conductors 21 have both a lower electrical conductivity and a lower magnetic permeability than the steel sheets 12a forming the rotor core 12.

Consequently, during rotation of the rotor 15, the heat conductors 21 may serve as an electric current blocker to block the flow of eddy current induced in the rotor 15, thereby reducing the amount of eddy current flowing through the permanent magnets 13 and thus the heat generated by the permanent magnets 13.

In the previous embodiment, each of the heat conductors 21 is formed in one piece and arranged to extend in the axial direction of the rotor core 12.

Consequently, it is possible to reduce the manufacturing cost of the rotor 15 in comparison with the case of forming each of the heat conductors 21 in a plurality of segments.

### [First Modification]

In the previous embodiment, the number of the heat conductors 21 is equal to the number of the permanent magnets 13. Each of the heat conductors 21 is embedded in a corresponding one of the permanent magnets 13 so as to conduct the heat generated by the corresponding permanent magnet 13.

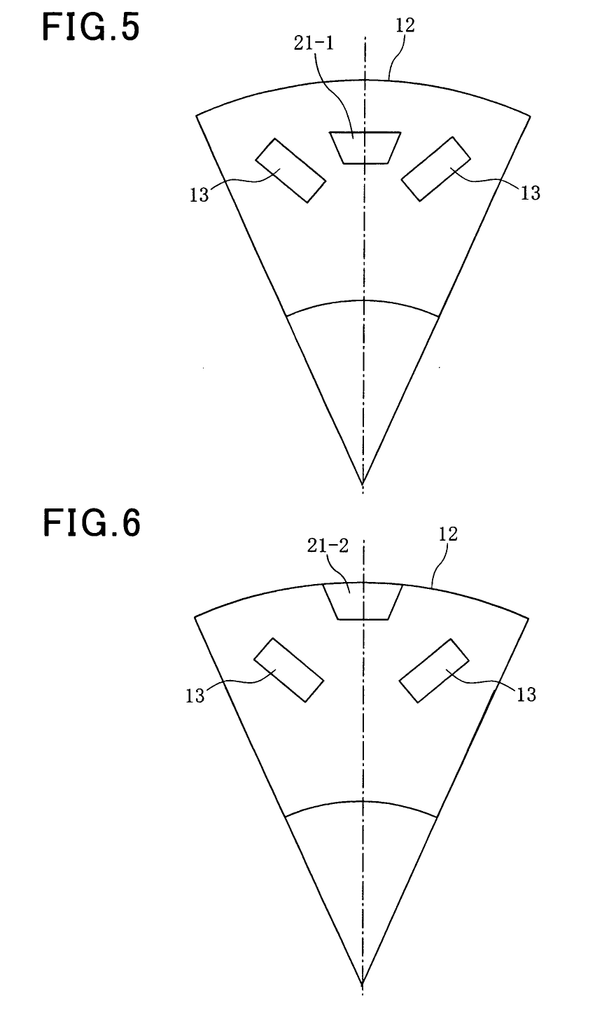

In comparison, referring to FIG. 5, in this embodiment, the number of heat conductors 21-1 is equal to half the number of the permanent magnets 13. Each of the heat conductors 21-1 is embedded in the rotor core 12 in the vicinity of a corresponding circumferentially-adjacent pair of the permanent magnets 13 which makes up one of the magnetic poles of the rotor 15. Moreover, each of the heat conductors 214 is positioned radially outside and equidistant from the corresponding pair of the permanent magnets 13.

With the above arrangement of the heat conductors 21-1, it is also possible to effectively cool all the permanent magnets 13. In addition, by reducing the number of the heat conductors, it is possible to reduce the manufacturing cost of the rotor 15.

### [Second Modification]

In the previous embodiment and modification, each of the heat conductors is completely embedded in the rotor core 12.

In comparison, referring to FIG. 6, in this modification, each of heat conductors 21-2 is partially embedded in the rotor core 12 with a radially outer surface thereof exposed from the rotor core 12. Moreover, as in the previous modification, each of the heat conductors 21-2 is positioned radially outside and in the vicinity of a corresponding circumferentially-adjacent pair of the permanent magnets 13 which makes up one of the magnetic poles of the rotor 15. Furthermore, each of the heat conductors 21-2 is equidistant from the corresponding pair of the permanent magnets 13.

With the above arrangement of the heat conductors 21-2, part of the heat generated by the permanent magnets 13 can be directly dissipated from the heat conductors 21-2 to the atmosphere via those radially outer surfaces of the heat conductors 21-2 which are exposed from the rotor core 12.

### [Modification 3]

In the previous embodiment and modifications, each of the heat conductors and permanent magnets is formed in one piece.

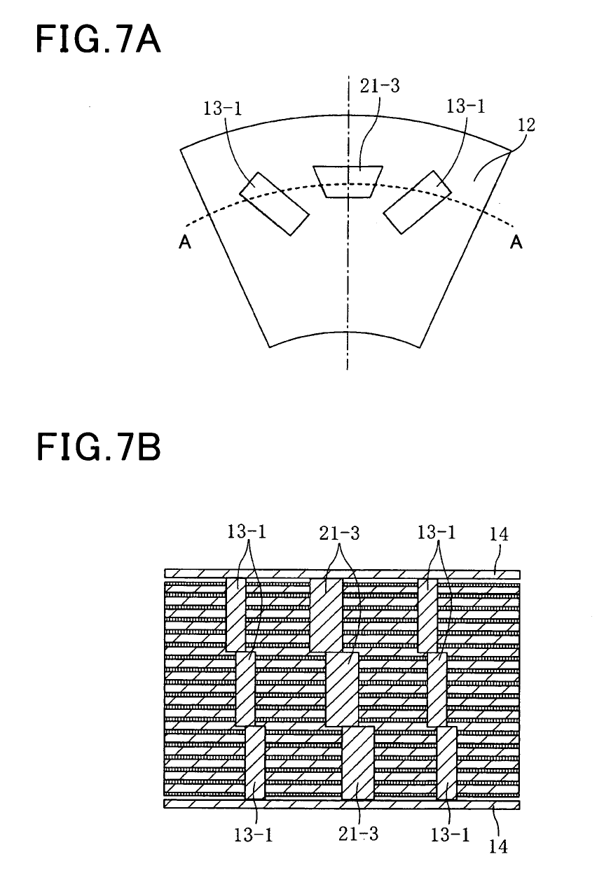

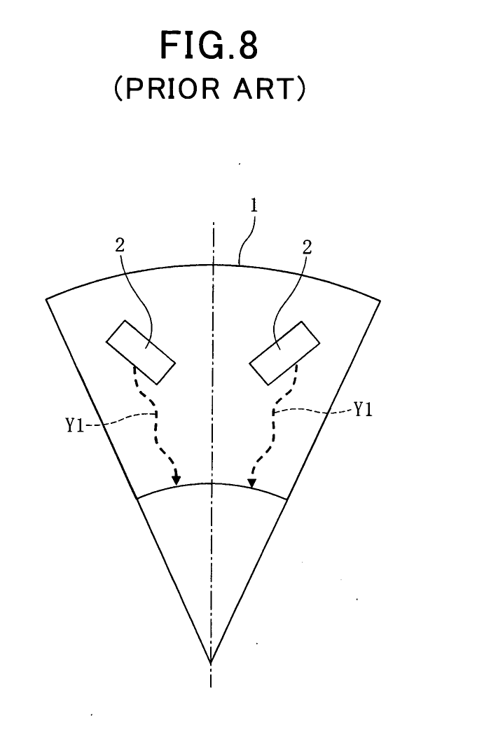

In comparison, referring to FIGS. 7A-7B, in this modification, each of heat conductors 21-3 is comprised of a plurality of heat conductor segments that are arranged in the axial direction of the rotor core 12 so as to partially abut one another and are offset from one another in the circumferential direction of the rotor core 12. Moreover, each of permanent magnets 13-1 is also comprised of a plurality of permanent magnet segments that are arranged in the axial direction of the rotor core 12 so as to partially abut one another and are offset from one another in the circumferential direction of the rotor core 12. In addition, as in the first modification, each of the heat conductors 21-3 is embedded in the rotor core 12 in the vicinity of a corresponding circumferentially-adjacent pair of the permanent magnets 13-1 which makes up one of the magnetic poles of the rotor 15. Moreover, each of the heat conductors 21-3 is positioned radially outside and equidistant from the corresponding pair of the permanent magnets 13-1.

With the above configuration, each of the heat conductors 21-3 and permanent magnets 13-1 is skewed in the circumferential direction of the rotor core 12, thereby reducing vibration and magnetic noise generated in the rotor 15.

While the above particular embodiment and modifications of the present invention have been shown and described, it will be understood by those skilled in the art that various further modifications, changes, and improvements may be made without departing from the spirit of the invention.

For example, in the previous embodiment, the rotor 15 includes the pair of end plates 14 that are disposed to respectively abut the axial end faces of the rotor core 12. However, it is also possible to omit either of the end plates 14 from the rotor 15.

Moreover, in the previous embodiment, the present invention is directed to the rotor 15 which is an inner-type rotor disposed radially inside the stator 18. However, the invention may also be applied to an outer-type rotor which is disposed radially outside a stator in an electric rotating machine.

What is claimed is:

1. A rotor for an electric rotating machine, the rotor comprising:
a hollow cylindrical rotor core having a pair of axial end faces that are opposite to each other in an axial, direction of the rotor core;
a plurality of permanent magnets that are embedded in the rotor core so as to be spaced from one another in a circumferential direction of the rotor core;
at least one annular plate disposed in abutment with a corresponding one of the axial end faces of the rotor core; and
a plurality of heat conductors embedded in the rotor core, each of the heat conductors extending so as to have an end thereof abutting the at least one annular plate.

2. The rotor as set forth in claim 1, wherein the rotor core is to be disposed so as to face a stator of the electric rotating machine in a radial direction of the rotor core, and
the heat conductors are positioned in the rotor core so as to be closer to the stator than the permanent magnets are.

3. The rotor as set forth in claim 1, wherein the number of the heat conductors is equal to the number of the permanent magnets, and
each of the heat conductors is embedded in the rotor core in the vicinity of a corresponding one of the permanent magnets.

4. The rotor as set forth in claim 1, wherein the number of the heat conductors is half the number of the permanent magnets, and
each of the heat conductors is embedded in the rotor core in the vicinity of a corresponding circumferentially-adjacent pair of the permanent magnets so as to be equidistant from the corresponding pair of the permanent magnets.

5. The rotor as set forth in claim 1, wherein each of the heat conductors is partially embedded in the rotor core to have one surface thereof exposed from the rotor core.

6. The rotor as set forth in claim 1, wherein the rotor core is comprised of a plurality of steel sheets that are laminated in the axial direction of the rotor core with a plurality of insulating layers interposed therebetween, and
the heat conductors have a higher heat conductivity than the insulating layers.

7. The rotor as set forth in claim 1, wherein the rotor core is comprised of a plurality of steel sheets that are laminated in the axial direction of the rotor core with a plurality of insulating layers interposed therebetween, and
the at least one annular plate has a higher heat conductivity than the insulating layers.

8. The rotor as set forth in claim 1, wherein the at least one annular plate comprises a pair of annular plates that are disposed to respectively abut the axial end faces of the rotor core, and
each of the heat conductors extends so as to have a pair of axial ends thereof respectively abutting the pair of the annular plates.

9. The rotor as set forth in claim 1, wherein the at least one annular plate comprises only a single annular plate.

10. The rotor as set forth in claim 1, wherein the rotor core is comprised of a plurality of steel sheets that are laminated in the axial direction of the rotor core, and
the heat conductors have a lower electrical conductivity than the steel sheets.

11. The rotor as set forth in claim 1, wherein the rotor core is comprised of a plurality of steel sheets that are laminated in the axial direction of the rotor core, and
the heat conductors have a lower magnetic permeability than the steel sheets.

12. The rotor as set forth in claim 1, wherein each of the heat conductors is formed in one piece and arranged to extend in the axial direction of the rotor core.

13. The rotor as set forth in claim 1, wherein, each of the heat conductors is comprised of a plurality of heat conductor segments that are arranged in the axial direction of the rotor core so as to partially abut one another and are offset from one another in the circumferential direction of the rotor core.
